(19) United States
(12) Patent Application Publication
(10) Pub. No.: US 2011/0214141 A1
(43) Pub. Date: Sep. 1, 2011

(54) CONTENT PLAYING DEVICE

(76) Inventor: Hideki OYAIZU, Tokyo (JP)

(21) Appl. No.: 13/026,907

(22) Filed: Feb. 14, 2011

(30) Foreign Application Priority Data
Feb. 26, 2010 (JP) 2010-042866

(51) Int. Cl. H04H 60/33

(52) U.S. Cl. 725/12; 725/10

(57) ABSTRACT

A system for generating information on viewer emotional response to content is disclosed. The system may include a viewer response input unit configured to capture local data representing at least one of local viewer audio or local viewer video of a local viewer's response to content data, the content data representing at least one of content audio or content video. The system may also include a viewer emotion analysis unit configured to generate local viewer emotion information indicative of an emotional response of the local viewer to the content data, based on the local data.

### CROSS-REFERENCE TO RELATED APPLICATION

This application claims priority of Japanese Patent Application No. 2010-042866, filed on Feb. 26, 2010, the entire content of which is hereby incorporated by reference.

### BACKGROUND

1. Technical Field

The present disclosure relates to a content playing device, and particularly relates to a content playing device enabling greater sensation of presence to be obtained when viewing contents, without hindering viewing.

2. Description of the Related Art

Traditionally, television receivers have often been one-way information transmission devices from producers of programs to viewers. In contrast, there have been proposed the CAPTAIN System (Character And Pattern Telephone Access Information Network System) and interactive services in terrestrial digital broadcasting, as frameworks for producing programs in which viewers can participate.

On the other hand, in recent years, development of networks has allowed for a great deal of communication between users. Particularly, communication tools called micro-blogs which enable short sentences to be typed has led to a preference for communication with higher immediacy. Using such tools allows users to easily talk about subjects on their mind at the present moment, lending to a sense of closeness and presence.

Also, a technique has been proposed in which text which a user or other users have written is superimposed on moving image contents being distributed by streaming, as a technique for users to have communication one with another (e.g., Japanese Unexamined Patent Application Publication No. 2008-172844). With this technique, text input by a user is transmitted to a streaming server, and the text and other text written by other users is superimposed on moving image contents being distributed.

Further, there is a technique wherein, upon a user viewing a program of a sport event or the like with a cellular phone inputting cheering information by operating the cellular phone, the cheering information is fed back to the venue where the sport event or the like is being held, and cheering sounds corresponding to the cheering information are played at the venue (e.g., Japanese Unexamined Patent Application Publication No. 2005-339479). With this technique, the cheering information of other users is also fed back to the cellular phone of the user viewing the program, so the user of the cellular phone can also experience a sense of presence.

### SUMMARY

However, with the aforementioned techniques, the very act of obtaining the sensation of presence when viewing contents, has hindered viewing the contents. For example, with the aforementioned interactive service, viewers could only do things such as selecting an answer from several options for a question in the program. This does not provide an atmosphere of spontaneous participation, and the viewers do not have much more than a sense of remotely participating in a limited manner.

Also, with communication by micro-blogs, and techniques such as superimposing input text on moving image contents being distributed by streaming, the users have had to actually input text of their own accord. Accordingly, if a user attempts to concentrate on viewing the content, typing and communication skills may suffer, but if the user attempts to concentrate on the typing, the user may be missing out on the full enjoyment of viewing the content.

Further, with the method for feeding back cheering information input at a cellular phone to the actual venue, the user transmits cheering and shouting as cheering information, so the user has to intentionally transmit this information, which may be a distraction from concentrating on the contents.

It has been found desirable to enable greater sensation of presence to be obtained when viewing contents, without hindering viewing.

Accordingly, there is disclosed a system for generating information on viewer emotional response to content. The system may include a viewer response input unit configured to capture local data representing at least one of local viewer audio or local viewer video of a local viewer's response to content data, the content data representing at least one of content audio or content video. The system may also include a viewer emotion analysis unit configured to generate local viewer emotion information indicative of an emotional response of the local viewer to the content data, based on the local data.

There is also disclosed a method for generating information on viewer emotional response to content. The method may include capturing local data representing at least one of local viewer audio or local viewer video of a local viewer's response to content data, the content data representing at least one of content audio or content video. The method may also include generating local viewer emotion information indicative of an emotional response of the local viewer to the content data, based on the local data.

Additionally, there is disclosed a device for combining content with information on viewer emotional response to the content. The device may include a viewer response input unit configured to capture local data representing at least one of local viewer audio or local viewer video of a local viewer's response to content data, the content data representing at least one of content audio or content video. The device may also include a viewer emotion analysis unit configured to generate local viewer emotion information indicative of an emotional response of the local viewer to the content data, based on the local data. Additionally, the device may include a transmission unit configured to transmit the local viewer emotion information to a server. The device may also include a synthesis unit. The synthesis unit may be configured to receive combined viewer emotion information from the server. Additionally, the synthesis unit may be configured to determine at least one of effect audio or effect video, based on the combined viewer emotion information. The synthesis unit may also be configured to combine at least one of effect audio data or effect video data, representing the determined at least one of effect audio or effect video, with the content data.

There is also disclosed a method for combining content with information on viewer emotional response to the content. A processor may execute a program to cause a content presenting device to perform the method. The program may be stored on a computer-readable medium. The method may include capturing local data representing at least one of local viewer audio or local viewer video of a local viewer's response to content data, the content data representing at least one of content audio or content video. The method may also include generating local viewer emotion information indicative of an emotional response of the local viewer to the content data, based on the local data. Additionally, the method may include transmitting the local viewer emotion information to a server. The method may also include receiving combined viewer emotion information from the server. In addition, the method may include determining at least one of effect audio or effect video, based on the combined viewer emotion information. The method may also include combining at least one of effect audio data or effect video data, representing the determined at least one of effect audio or effect video, with the content data.

### BRIEF DESCRIPTION OF THE DRAWINGS

FIG. 1 is a diagram illustrating the configuration of a content viewing system consistent with an embodiment of the present invention;

FIG. 2 is a diagram illustrating a configuration example of a client processing unit;

FIG. 3 is a flowchart for describing synthesizing processing by a client device, and distribution processing by a server;

FIG. 4 is a flowchart for describing viewing information generating processing by the client device, and consolidation processing by the server; and

FIG. 5 is a block diagram illustrating a configuration example of a computer.

### DETAILED DESCRIPTION

An embodiment of the present invention will be described with reference to the drawings. Configuration Example of Content Viewing System

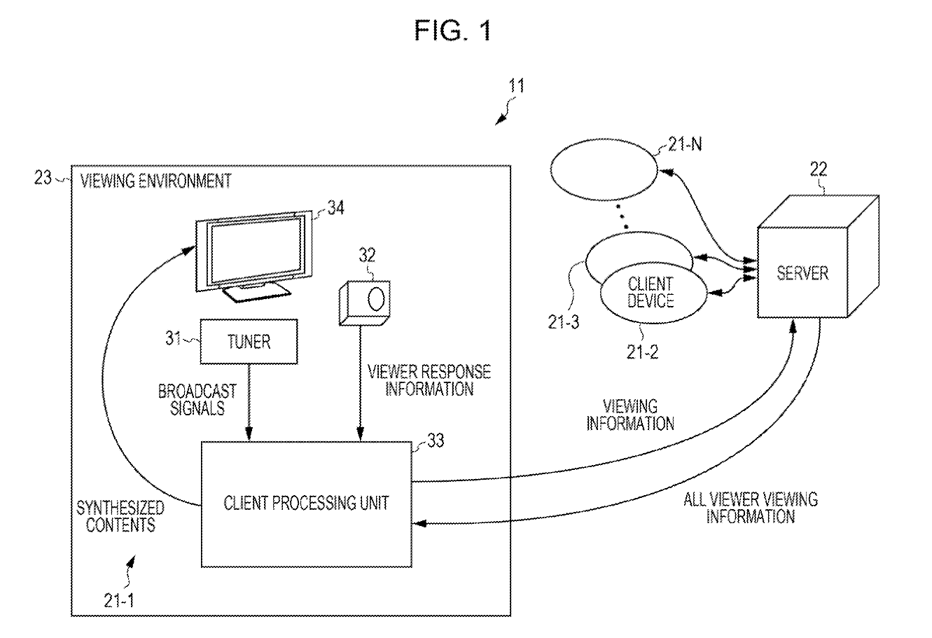

FIG. 1 is a diagram of a configuration example of a content viewing system consistent with an embodiment of the present invention. A content viewing system 11 is configured of client device 21-1 through client device 21-N, and a server 22 connected to the client device 21-1 through client device 21-N. For example, the client device 21-1 through client device 21-N and the server 22 are connected with each other via a network, such as the Internet, which is not shown.

The client device 21-1 through client device 21-N receive and play contents, such as television broadcast programs and the like. Note that in the event that the client device 21-1 through client device 21-N do not have to be distinguished individually, these will be collectively referred to simply as “client device 21”.

For example, the client device 21-1 is installed in a viewing environment 23 such as the home of a user, and receives broadcast signals of a program by airwaves broadcast from an unshown broadcasting station, via a broadcast network. The client device 21-1 is configured of a tuner 31, viewer response input unit 32, client processing unit 33, and display unit 34.

The tuner 31 receives broadcast signals transmitted from the broadcasting station, separates broadcast signals of a program of a channel specified by the user (i.e., broadcast signals indicative of content data representing at least one of content audio or content video) from the broadcast signals, and supplies this to the client processing unit 33. Hereinafter, a program to be played from broadcast signals will be referred to simply as “content”.

The viewer response input unit 32 is made up of a camera and microphone for example, which obtains video (moving images) and audio (i.e., local viewer video and local viewer audio, respectively) of the user viewing the content, as viewer response information (i.e., local data representing the local viewer video and the local viewer audio) indicating the response of the user as to the content, and supplies this to the client processing unit 33.

The client processing unit 33 uses the viewer response information from the viewer response input unit 32 and generates viewer information regarding the content which the user is viewing, and transmits this to the server 22 via a network such as the Internet or the like.

Now, viewer information is information relating to the response of the user as to the content, and the viewer information includes viewer response information, emotion building information (i.e., local viewer emotion information), and channel information. Note that emotion building information is information indicating the degree of emotion building of the user, i.e., the degree of how emotional the user is becoming while viewing the content or the intensity of the emotional response of the user, and channel information is information indicating the channel of the content being viewed.

Also, the client processing unit 33 receives all viewer viewing information (i.e., combined viewer emotion information) transmitted from the server 22, via a network such as the Internet or the like. This all viewer viewing information is information generated by consolidating viewer information from each client device 21 connected to the server 22, with the all viewer viewing information including channel information, average emotion building information indicating the average value of emotion building information of all viewers, and viewer response information of each viewer.

Note that it is sufficient that the average emotion building information included in the all viewer viewing information indicates the average degree of emotional building of all users, and does not have to be the average value of emotion building information. Accordingly, the viewer response information included in the all viewer viewing information may be all of the viewer response information of part of the viewers, part of the information of the viewer response information of all of the viewers, or part of the information of the viewer response information of part of the viewers. Further, the all viewer viewing information may include the number of viewer information consolidated, i.e., information including the number of viewers.

The client processing unit 33 synthesizes emotion building effects identified from the all viewer viewing information obtained from the server 22 with the content supplied from the tuner 31, and supplies the obtained content (hereinafter also referred to as “synthesized content” as appropriate), so as to be played.

Now, emotion building effects are made up of video and audio of users making up the viewer response information, audio data such as prepared laughter, shouting, cheering voices, and, so forth. In other words, emotion building effects are data of video and audio and the like representing the emotion building of a great number of viewers (users) as to the content. Note that the emotion building effects may be actual responses of users as to the content at least one of remote viewer audio or remote viewer video of a remote viewer's response to the content), or may be audio or the like such as shouting or the like, representing the responses of virtual viewers.

The display unit 34 is configured of a liquid crystal display and speaker and so forth for example, and plays the synthesized content supplied from the client processing unit 33. That is to say, the display unit 34 displays video (moving images) making up the synthesized contents, and also outputs audio making up the synthesized contents. Thus, live viewing information of the entirety of viewers viewing the content, i.e., emotion building effects obtained from the all viewer viewing information, is synthesized with the content and played, whereby users viewing the contents can obtain a sense of unity among viewers, and a sense of presence.

Note that the client device 21-2 through client device 21-N are configured in the same way as with the client device 21-1, and that these client devices 21 operate in the same way as well.

### Configuration Example of Client Processing Unit

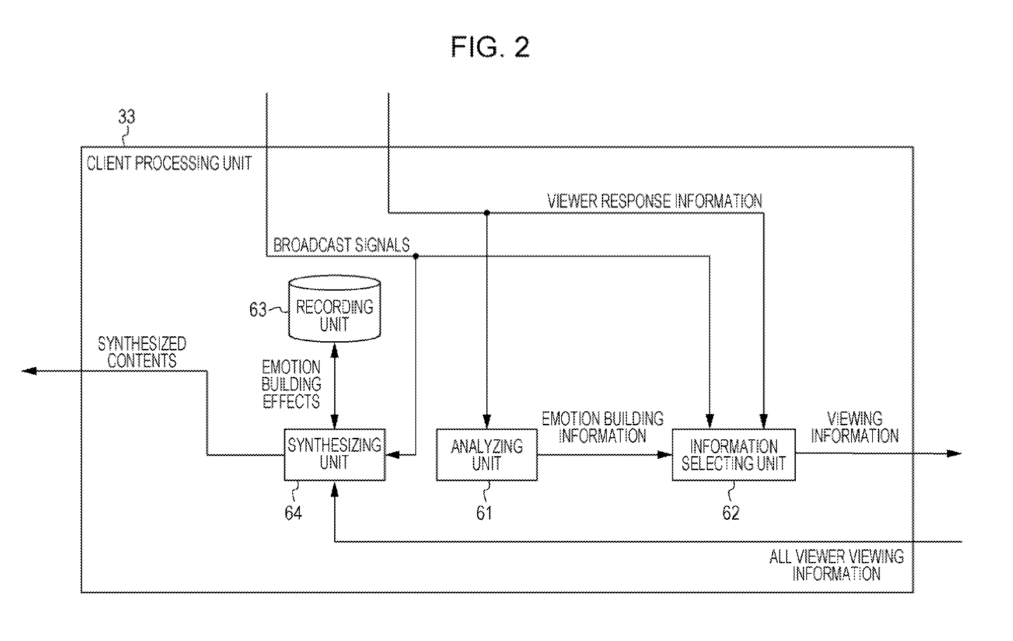

The client processing unit 33 in FIG. 1 is, in further detail, configured as shown in FIG. 2. Specifically, the client processing unit 33 is configured of an analyzing unit (i.e., a viewer emotion analysis unit) 61, an information selecting unit (i.e., a transmission unit) 62, a recording unit 63, and a synthesizing unit (i.e., a synthesis unit) 64.

The analyzing unit 61 analyzes viewer response information supplied from the viewer response input unit 32, generates emotion building information, and supplies this to the information selecting unit 62. For example, the analyzing unit 61 performs motion detection of moving images as viewer reaction information, calculates the amount of motion of the user included in the moving image, and takes the obtained motion amount as emotion building information of the user. In this case, the greater the user motion amount is, for example, the greater the degree of emotion building of the user is, and the greater the value of emotion building information is.

Also, for example, the analyzing unit 61 takes change in the intensity of audio, as viewer response information i.e., as emotion building information of a value indicating the amount of change in amount of sound. In this case, the greater the change in the amount of sound is, for example, the greater the degree of emotion building of the user is, and the greater the value of emotion building information is.

Note that emotion building information is not restricted to motion and sound of the user, and may be generated from other information obtained from the user, such as facial emotions or the like, as long as the degree of emotion building of the user can be indicated. Also, emotion building information maybe information made up of multiple elements indicating the response of the user when viewing the content, such as change in the amount of movement and sound of the user, and may be information obtained by values of the multiple elements being added in a weighted manner.

Further, the emotion building information is not restricted to the degree of emotion building of the user and may also include types of emotion building of the user, such as laughter or shouting, i.e., information indicating the types of emotions of the user.

The information selecting unit 62 generates viewer information using the viewer response information from the viewer response input unit 32, the content from the tuner 31, and the emotion building information from the analyzing unit 61, and transmits this to the server 22.

Note that the viewer response information included in the viewing information may be viewer response information obtained at the viewer response input unit 32 itself, or may be a part of the viewer response information, such as moving images of the user alone, for example. Also, the viewing information is transmitted to the server 22 via a network, and accordingly is preferably information which is as light as possible, i.e., information with little data amount. Further, the viewing information may include information of the device which is the client device 21, and so forth.

The recording unit 63 records emotion building effects prepared beforehand, and supplies emotion building effects recorded to the synthesizing unit 64 as appropriate. Note that the emotion building effects recorded in the recording unit 63 are not restricted to data such as moving images or audio or the like prepared beforehand, and may be the all viewer viewing information received from the server 22, or data which is part of the all viewer viewing information, or the like. For example, if the viewer response information included in the all viewer viewing information received from the server 22 is recorded, and used as emotion building effects at the time of viewing other contents, variations in the expression of the degree of emotion building can be increased.

The synthesizing unit 64 receives the all viewer viewing information transmitted from the server 22, and selects some of the emotion building effects recorded in the recording unit 63, based on the received all viewer viewing information. Also, the synthesizing unit 64 synthesizes one or multiple emotion building effects selected with the content supplied from the tuner 31, thereby generating synthesized content (i.e., combined data representing at least one of combined audio or combined video), and the synthesized content is supplied to the display unit 34 and played.

### Description of Synthesizing Processing and Distribution Processing

Next, the operations of the client device 21 and server 22 will be described. For example, upon the user operating the client unit 21 to instruct starting of viewing of a content of a predetermined channel, the client device 21 starts the synthesizing processing, receives the content instructed by the user and generates synthesized content, and plays the synthesized content. Also, upon the synthesizing processing being started at the client device 21, the server 22 starts distribution processing, so as to distribute the all viewer viewing information of the content which the user of the client device 21 is viewing, to each client device 21.

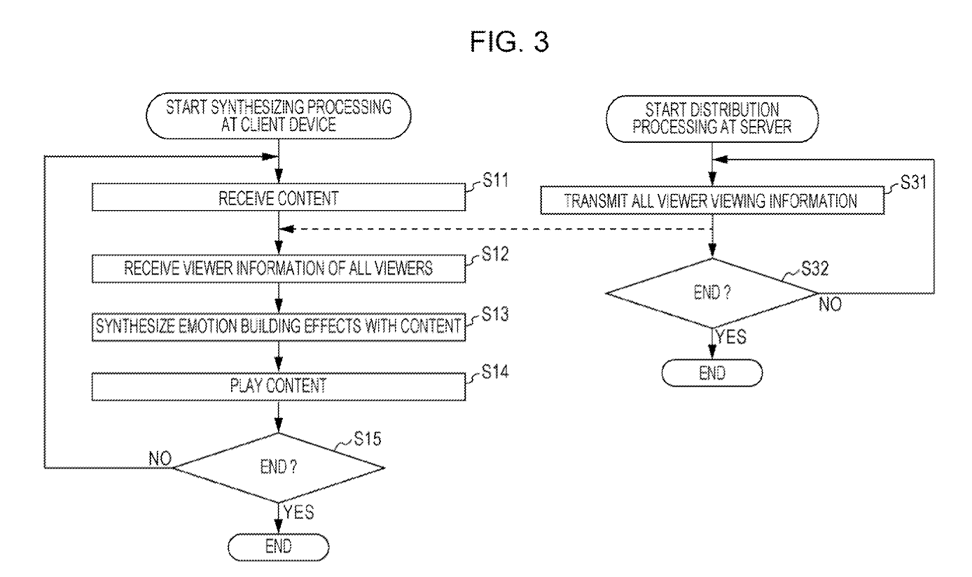

The following is a description of synthesizing processing by the client device 21 and distribution processing by the server 22, with reference to the flowchart in FIG. 3.

In step S11, the tuner 31 of the client device 21 receives content transmitted from a broadcasting station, and supplies this to the analyzing unit 61, information selecting unit 62, and synthesizing unit 64. That is to say, broadcast signals that have been broadcast are received, and data of the content of the channel specified by the user is extracted for the received broadcast signals. Also, in step S31, the server 22 transmits the all viewer viewing information obtained regarding the content being played at the client device 21, to the client device 21 via the network.

In step S32, the server 22 determines whether to end processing for transmitting (distributing) the all viewer viewing information of the content to the client device 21 playing the content. For example, in the event that the client device 21 playing the relevant content ends playing of the content, determination is made to end the processing. Ending of playing of content is notified from the client device 21 via the network, for example.

In the event that determination is made in step S32 that processing is not to end, the flow returns to step S31, and the above-described processing is repeated. That is to say, newly-generated all viewer viewing information is successively transmitted to the client device 21.

On the other hand, in the event that determination is made in step S32 that processing is to end, the server 22 stops transmitting of the all viewer viewing information, and the distribution processing ends.

Also, in the event that all viewer viewing information is transmitted from the server 22 to the client device 21 in the processing in step S31, in step S12 the synthesizing unit 64 receives the all viewer viewing information transmitted from the server 22.

In step S13, the synthesizing unit 64 selects emotion building effects based on the received all viewer viewing information, and synthesizes the selected emotion building effects with the content supplied from the tuner 31.

Specifically, the synthesizing unit 64 obtains, from the recording unit 63. emotion building effects determined by the value of average emotion building information included in the all viewer viewing information, synthesizes the video and audio as the obtained emotion building effects with the video and audio making up the content, and thereby generates synthesized content.

At this time, for example, video to serve as emotion building effects may be identified from an average value of the amount of moving of the users included in the average emotion building information, and audio to serve as emotion building effects may be identified from an average value of the amount of change in the amount of sound of the users included in the average emotion building information.

Note that selection of emotion building effects may be made with any selection method, as long as suitable emotion building effects are selected in accordance with the magnitude of emotion building of viewers overall, indicated in the average emotion building information. Also, the magnitude of video or volume of audio serving as emotion building effects may be adjusted to a magnitude corresponding to the average emotion building information value, or emotion building effects of a number determined according to the average emotion building information value may be selected.

Further, video and audio serving as viewer response information included in the all viewer viewing information may be synthesized with the content. Synthesizing actual reactions of other users (other viewers) viewing the relevant content in this way, with the content, as emotion building effect, allows a greater sense of presence and sense of unity with other viewers.

Note that depending on the state of emotion building of all viewers indicated by the all viewer viewing information, a situation may be created wherein no emotion building content is be synthesized with the content. That is to say, in the event that the degree of emotion building is low, no emotion building effects are synthesized with the content in particular, and the content is played as is.

In step S14, the synthesizing unit 64 supplies the generated synthesized content to the display unit 34, and plays the synthesized content. The display unit 34 displays video making up the synthesized content from the synthesizing unit 64, and also outputs audio making up the synthesized content. Accordingly, shouting, laughter, cheering, and so forth, reflecting the responses of the users of the other client devices 21 viewing the content, and video of the users of the other clients viewing the content, and so forth, are played along with the content.

In step S15, the client processing unit 33 determines whether or not to end the processing for playing the synthesized content. For example, in the event that the user operates the client device 21 and instructs ending of viewing of the content, determination is made to end the processing.

In the event that determination is made in step S15 that processing is not to end, the flow returns to step S11, and the above-described processing is repeated. That is to say, processing for generating synthesized content and playing this is continued.

On the other hand, in the event that determination is made in step S15 that processing is to end, the client device 21 notifies the server 22 via the network to the effect that viewing of content is to end, and the synthesizing processing ends.

Thus, the client device 21 obtains all viewer viewing information from the server 22, and uses the obtained all viewer viewing information to synthesize emotion building effects suitable for the content.

Accordingly, feed back of emotions such as emotion building of other viewers can be received an real time and the responses of other viewers can be synthesized with the content. As a result, viewers viewing the content can obtain a realistic sense of presence such as if they were in a stadium or movie theater or the like, and can obtain a sense of unity with other viewers, while in a home environment. Moreover, the users do not have to input any sort of information text indicating describing how they feel about the content or so forth, while viewing the content, so viewing of the content is not hindered.

Generally, when watching sports in a stadium or the like, or when viewing movies in a movie theater, often the spectators or viewers exhibit the same response in the same situation, so the emotion building within that venue brings about the sense of unity and sense of presence in the venue.

With the content viewing system 11, the responses of multiple users viewing the same content are reflected in the content being viewed in real time. Accordingly, the users can obtain a sense of unity and sense of presence, which is closer to the sense of unity and sense of presence obtained when actually watching sports or when viewing movies in a movie theater.

Also, with the client device 21, emotion building effects prepared beforehand are synthesized with the content, so the content does not have to be changed in any particular way at the distribution side of the content, and accordingly this can be applied to already-existing television broadcasting programs and the like.

### Description of Viewer Information Generating Processing and Consolidation Processing

Further, upon the user instructing starting of viewing contents, and the above-described synthesizing processing and distribution processing being started, viewing information generating processing in which viewing information is generated, and consolidating processing wherein all viewer viewing information consolidating the viewing information is generated, are performed between the client device 21 and server 22, parallel with this processing.

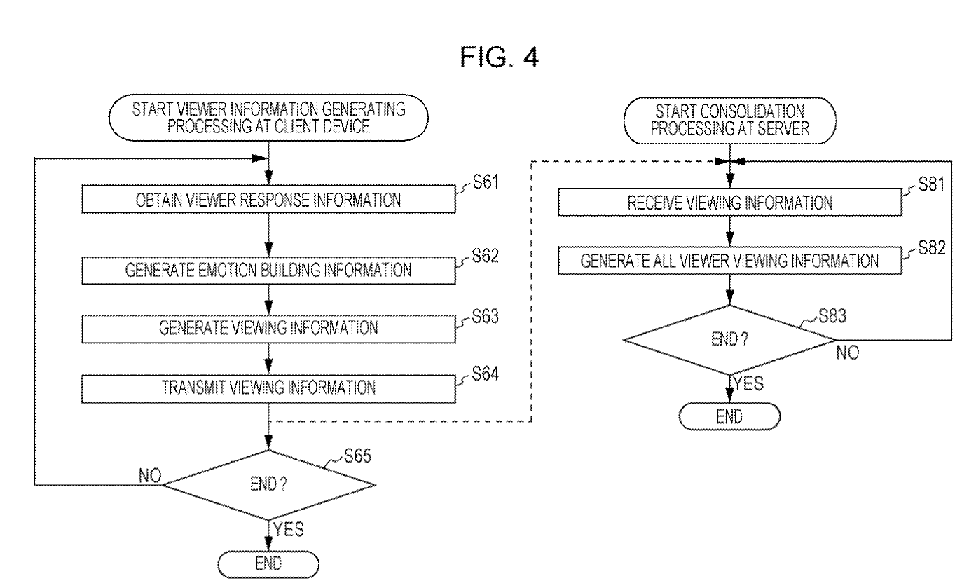

Description will be made regarding the viewing information generating processing by the client device 21 and the consolidation processing by the server 22, with reference to the flowchart in FIG. 4.

Upon starting of viewer information being started by the user, in step S61, the viewer response input unit 32 obtains the viewer response information of the user viewing the display 34 nearby the client device 21, and supplies this to the analyzing unit 61 and information selection unit 62. For example, information indicating the response of the user viewing the synthesized content, such as video and audio and the like of the user, is obtained as viewer response information.

In step S62, the analyzing unit 61 generates emotion building information using the viewer response information supplied from the viewer response input unit 32, and supplies this to the information selection unit 62. For example, the amount in change in the amount of motion of the user or the amount of sound at the time of viewing the synthesized content, obtained from the viewer response information, is generated as emotion building information.

In step S63, the information selecting unit 62 generates viewer information relating to the individual user of the client device 21, using the content from the tuner 31, the viewer response information from the viewer response input unit 32, and emotion building information from the analyzing unit 61.

In step S64, the information selection unit 62 transmits the generated viewing information to the server 22 via the network.

In step S65, the client processing unit 33 makes determination regarding whether or not to end the processing of generating viewing information and transmitting this to the server 22. For example, in the event that the user has instructed ending of viewing the content, i.e., in the event that the synthesizing processing in FIG. 3 has ended, then determination is made that the processing is to be ended.

In step S65, in the event that determination is made the processing is not to end, the flow returns to step S61, and the above-described processing is repeated. That is to say, viewer response information at the next point-in-time is obtained and new viewing information is generated.

On the other hand, in the event that determination is made in step S65 that the processing is to end, the client device 21 stops the processing which it is performed, and the viewing information generating processing ends.

Also, in the event that viewing information is transmitted from the client device 21 to the server 22, in step 381 the server 22 receives the viewing information transmitted from the client device 21.

At this time, the server 22 receives viewing information from all client devices 21 playing the relevant content of a predetermined channel. That is to say, the server 22 receives provision of viewing information including emotion building information from all users viewing the same content.

In step S82, the server 22 uses the received viewing information to generate all viewer viewing information regarding the content of the predetermined channel.

For example, the server 22 generates channel information identifying the content, average emotion building information indicating the degree of emotion building of all viewers, and all viewer viewing information made up of viewer response information of part or all of the viewers. Here, average emotion building information is an average value of emotion building information obtained from each client device 21 or the like, for example.

The all viewer viewing information generated in this way is transmitted to all client devices 21 which play the content of the predetermined channel in the processing of step S31 in FIG. 3.

In step S83, the server 22 determines whether or not to end the processing for generating the all viewer viewing information. For example, in the event that the distribution processing in FIG. 3 executed in parallel with the consolidating processing has ended, determination is made to end.

In the event that determination is made in step S83 not to end the processing, the flow returns to step S81, and the above-described processing is repeated. That is to say, all viewer viewing information is generated based on the newly received viewing information.

On the other hand, the event that determination is made in step S83 to end the processing, the server 22 stops the processing which it is performing, and the consolidation processing ends.

In this way, the client device 21 obtains the response of the user viewing the content as viewer response information, and transmits viewing information including the viewer response information to the server 22. Accordingly, information relating to the responses of the user viewing the content can be supplied to the server 22, and as a result, the user can be provided with a more realistic sense of presence and sense of unity. Moreover, in this case, the users do not have to input text or the like describing how they feel about the content, so viewing of the content is not hindered.

Now, in the above description, a program of a television broadcast has been described as an example of a content viewed by a user, but the content may be any other sort of content, such as audio (e.g., music) or the like. Also, the arrangement is not restricted to one wherein the content is transmitted from the server 22 to the client device 21 as such; any arrangement or configuration serving as the server 22 or as an equivalent thereof may be used to transmit the content, and the content may be directly transmitted to the user, or may be transmitted thereto via any sort of communication network, cable-based or wireless, including the Internet.

Note that the above-described series of processing may be executed by hardware, or may be executed by software. In the event of executing the series of processing by software, a program making up the software thereof is installed into a computer built into dedicated hardware, or a general-purpose personal computer capable executing various types of functions by installing various types of programs for example, or the like, from a program recording medium.

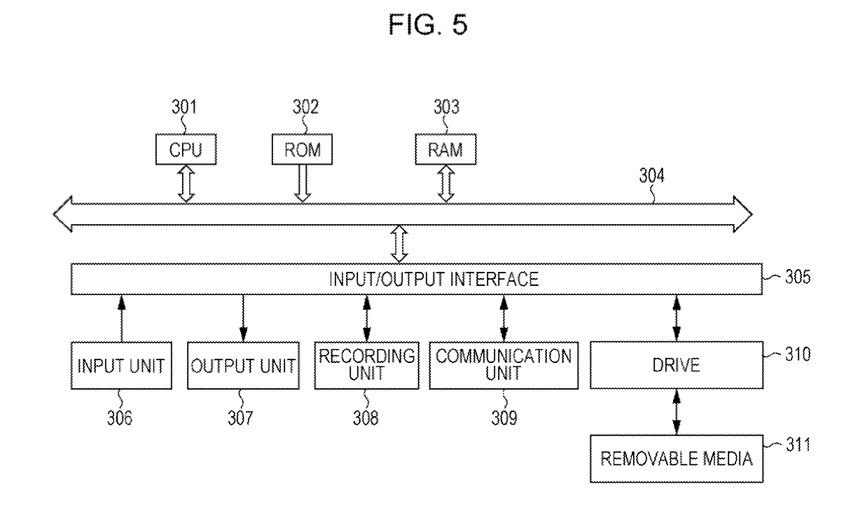

FIG. 5 is a block diagram illustrating a hardware configuration example of a computer for executing the program of the above-described series of processing. In the computer, a CPU (Central Processing Unit) 301, ROM (Read Only Memory) 302, and RAM (Random Access Memory) 303, are mutually connected by a bus 304.

The bus 304 is further connected with an input/output interface 305. connected to the input/output interface 305 are an input unit 306 made up of a keyboard, mouse, microphone, and so forth, an output unit 307 made up of a display, speaker, and so forth, a recording unit 308 made up of a hard disc or non-volatile memory or the like, a communication unit 309 made up of a network interface or the like, and a drive 310 for driving removable media 311 such as a magnetic disk, optical disc, magneto-optical disc, or semiconductor memory or the like.

With a computer configured as described above, the CPU 301 loads the program recorded in the recording unit 308, via the input/output interface 305 and bus 304, to the RAM 303, and executes the program, for example, whereby the above-described series of processing is performed.

The program which the computer (CPU 301) executes is provided by, for example, being recorded in removable media 311 which is packaged media such as magnetic disks (including flexible disks), optical discs (including CD-ROM (Compact Disc-Read Only Memory), DVD (Digital Versatile Disc) or the like), magneto-optical discs, or semiconductor memory, or via a cable or wireless transmission medium, such as a local area network, the Internet, digital satellite broadcasting, and so forth.

The program can be installed into the recording unit 308 via the input/output interface 305 by the removable media 311 being mounted to the drive 310. Also, the program can be installed in the recording unit 308 by being received and the communication unit 309 via a cable or wireless transmission medium. Alternatively, the program may be installed in the ROM 302 or storage unit 308 beforehand.

Note that the program which the computer executes may be program regarding which processing is performed in time sequence following the order described in the Present Specification, or may be a program regarding which processing is performed in parallel or at a certain timing, such as when a call-up is performed.

Note that embodiments of the present invention are not restricted to the above-described embodiment, and that various modification can be made without departing from the essence of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A system for generating information on viewer emotional response to content, comprising:
a viewer response input unit configured to capture local data representing at least one of local viewer audio or local viewer video of a local viewer's response to content data, the content data representing at least one of content audio or content video; and
a viewer emotion analysis unit configured to generate local viewer emotion information indicative of an emotional response of the local viewer to the content data, based on the local data.

2. The system of claim 1, comprising a tuner configured to receive a broadcast signal indicative of the content data.

3. The system of claim 1, wherein the viewer response input unit is configured to capture the local data as the content data is presented to the local viewer.

4. The system of claim 3, wherein the local viewer emotion information indicates an intensity of the emotional response of the local viewer to the presented content data.

5. The system of claim 4, comprising a server and a plurality of content presenting devices, the content presenting devices including transmission units configured to transmit to the server at least one of the local data or the local viewer emotion information.

6. The system of claim 5, wherein the server is configured to combine a plurality of local viewer emotion information to create combined viewer emotion information.

7. The system of claim 6, comprising a synthesis unit configured to:
determine at least one of effect audio or effect video, based on the combined viewer emotion information; and
combine at least one of effect audio data or effect video data, representing the determined at least one of effect audio or effect video, with the content data to create combined data representing at least one of combined audio or combined video.

8. The system of claim 7, wherein:
the server is configured to transmit the combined viewer emotion information to at least one of the content presenting devices;
the at least one of the content presenting devices includes the synthesis unit; and
the synthesis unit is configured to receive the combined viewer emotion information from the server.

9. The system of claim 7, wherein at least one of the content presenting devices includes a display unit configured to present the combined data to the local viewer.

10. The system of claim 7, wherein the synthesis unit is configured to output the combined data to a display unit of one of the content presenting devices.

11. The system of claim 7, wherein the at least one of effect audio or effect video includes at least one of remote viewer audio or remote viewer video of a remote viewer's response to the content data as the content data is presented to the remote viewer.

12. The system of claim 7, wherein the at least one of effect audio or effect video represents responses of a plurality of viewers to the content data as the content data is presented to the plurality of viewers.

13. The system of claim 6, wherein the combined viewer emotion information is indicative of an average intensity of emotional responses of a plurality of viewers to the content data as the content data is presented to the plurality of viewers.

14. The system of claim 6, wherein the server receives the plurality of local viewer information from the content presenting devices.

15. The system of claim 1, wherein the viewer emotion analysis unit generates the local viewer emotion information based on an amount of movement of the local viewer.

16. The system of claim 15, wherein the viewer emotion analysis unit generates the local viewer emotion information based on a change in the amount of sound generated by the local viewer.

17. The system of claim 1, wherein the viewer emotion analysis unit generates the local viewer emotion information based on a change in the amount of sound generated by the local viewer.

18. A device for combining content with information on viewer emotional response to the content, comprising:
a viewer response input unit configured to capture local data representing at least one of local viewer audio or local viewer video of a local viewer's response to content data, the content data representing at least one of content audio or content video;
a viewer emotion analysis unit configured to generate local viewer emotion information indicative of an emotional response of the local viewer to the content data, based on the local data;
a transmission unit configured to transmit the local viewer emotion information to a server; and
a synthesis unit configured to:
receive combined viewer emotion information from the server;
determine at least one of effect audio or effect video, based on the combined viewer emotion information; and
combine at least one of effect audio data or effect video data, representing the determined at least one of effect audio or effect video, with the content data.

19. A method for generating information on viewer emotional response to content, comprising:
capturing local data representing at least one of local viewer audio or local viewer video of a local viewer's response to content data, the content data representing at least one of content audio or content video; and
generating local viewer emotion information indicative of an emotional response of the local viewer to the content data, based on the local data.

20. A method for combining content with information on viewer emotional response to the content, comprising:
capturing local data representing at least one of local viewer audio or local viewer video of a local viewer's response to content data, the content data representing at least one of content audio or content video;
generating local viewer emotion information indicative of an emotional response of the local viewer to the content data, based on the local data;
transmitting the local viewer emotion information to a server;
receiving combined viewer emotion information from the server;
determining at least one of effect audio or effect video, based on the combined viewer emotion information; and
combining at least one of effect audio data or effect video data, representing the . determined at least one of effect audio or effect video, with the content data.

21. A non-transitory, computer-readable storage medium storing a program that, when executed by a processor, causes a content presenting device to perform a method for combining content with information on viewer emotional response to the content, the method comprising:
capturing local data representing at least one of local viewer audio or local viewer video of a local viewer's response to content, data, the content data representing at least one of content audio or content video;
generating local viewer emotion information indicative of an emotional response of the local viewer to the content data, based on the local data;
transmitting the local viewer emotion information to a server;
receiving combined viewer emotion information from the server;
determining at least one of effect audio or effect video, based on the combined viewer emotion information; and
combining at least one of effect audio data or effect video data, representing the determined at least one of effect audio or effect video, with the content data.
